(19) United States
(12) Patent Application Publication
(10) Pub. No.: US 2008/0106070 A1
(43) Pub. Date: May 8, 2008

(54) Foldable stroller capable of being automatically locked in a folded state

(76) Inventor: Red Lan, Taipei Hsien (TW)

Correspondence Address: COURTNEY STANIFORD & GREGORY LLP, P.O. BOX 9686, SAN JOSE, CA, 95157, US

(21) Appl. No.: 11/592,582

(22) Filed: Nov. 2, 2006

(51) Int. Cl. B62B 5/00

(52) U.S. Cl. 280/647

(57) ABSTRACT

A stroller includes a handle frame disposed pivotally on a front end portion of a wheel frame. A strut has a front end connected pivotally to the handle frame, and a rear end disposed movably on the wheel frame and locked releaseably on the wheel frame. A retaining mechanism includes at least one retaining seat attached to the handle frame, and at least one retaining hook unit including a hook plate that is disposed in a generally horizontal position on the wheel frame. When the stroller is folded, the hook plate is pivoted upwardly to an upright position whereat the hook plate engages the retaining seat so as to lock the stroller in the folded state.

### BACKGROUND OF THE INVENTION

1. Field of the Invention

This invention relates to a stroller, and more particularly to a foldable stroller capable of being automatically locked in a folded state.

2. Description of the Related Art

Referring to FIGS. 1 and 2, a stroller 9 disclosed in German Utility Model No. 20 2005 0083690 includes a wheel frame 91, a handle frame 92 disposed pivotally on a front end portion of the wheel frame 91, a pair of left and right strut-positioning mechanisms 93 disposed respectively on two mounting seats 911 of the wheel frame 91, a strut 94 disposed between and connected pivotally to two swing rods 921 of the handle frame 92, two separating mechanisms 95 interposed between the handle frame 92 and the wheel frame 91, and a pair of left and right retaining mechanisms 96 for locking the stroller 9 in a folded state.

The handle frame 92 further includes a grip member 923 connected rotatably to the swing rods 921 by two pivot pins 922. The strut 94 has a pair of inclined-left and right supporting sections 941 connected pivotally to the handle frame 92, and a horizontal engagement section 942 connected fixedly to the left and right supporting sections 941 and locked releaseably at a front limit position on the wheel frame 91 by the strut-positioning mechanisms 93. Each of the separating mechanisms 95 includes a torsional spring 951 for biasing the handle frame 92 to pivot forwardly and upwardly to a normal position shown in FIG. 1, and a damping cylinder 952 disposed between the mounting seats 911 and the swing rods 921. Each of the retaining mechanisms 96 includes a retaining hook 961, a pivot pin 962 for connecting the retaining hook 961 rotatably to the wheel frame 91, a torsional spring 963 for biasing the retaining hook 961 to a normal position shown in FIG. 1, and a horizontal retaining rod 964 attached to the handle frame 92. Each of the retaining hooks 961 has a top hook portion 965 and a lower pedal portion 966 disposed below the mounting seats 911.

To fold the stroller 9, the swing rods 921 are pivoted toward the wheel frame 91, and the grip member 923 is pivoted respectively and forwardly relative to the swing rods 921 about the pivot pins 922. During pivoting movement of the grip member 923, the strut-positioning mechanisms 93 are activated so as to allow the engagement section 942 of the strut 94 to move on the wheel frame 91. Hence, the retaining rods 964 move on the top hook portions 965 of the retaining hooks 961 so as to push and pivot the retaining hooks 961 forwardly against the biasing action of the torsional springs 963. When the retaining rods 964 move beyond the top hook portions 965 of the retaining hooks 961, the torsional springs 963 pivot the top hook portions 965 of the retaining hooks 961 rearwardly to engage the retaining rods 964, thereby automatically locking the stroller 9 in the folded state. The pedal portions 966 of the retaining hooks 961 can be stepped on to thereby remove the retaining rods 964 from the retaining hooks 961. Since the structure and operation of the strut-positioning mechanism 93 are not relevant to the improvement of this invention, and are disclosed in German Utility Model No. 20 2005 0083690, a description thereof will be omitted.

Although the stroller 9 can be automatically locked in the folded state by the engagement between the retaining rods 964 and the retaining hooks 961, the presence of the retaining hooks 961 destroys the integral outer appearance of the stroller 9. Furthermore, articles disposed on or adjacent to the stroller 9 may be inadvertently hooked by the retaining hooks 961, thereby resulting in damage thereto.

### SUMMARY OF THE INVENTION

The object of this invention is to provide a stroller that can be automatically locked in a folded state and that can overcome the aforesaid disadvantages associated with the prior art.

According to this invention, a stroller includes a handle frame disposed pivotally on a front end portion of a wheel frame. A strut has a front end connected pivotally to the handle frame, and a rear end disposed movably on the wheel frame and locked releaseably on the wheel frame. A retaining mechanism includes at least one retaining seat attached to the handle frame; and at least one retaining hook unit including a hook plate that is disposed in a generally horizontal position on the wheel frame. When the stroller is folded, the hook plate is pivoted upwardly to an upright position whereat the hook plate engages the retaining seat so as to lock the stroller in the folded state.

Since the hook plate is disposed in the horizontal position when the stroller is unfolded, the integral outer appearance of the stroller can be maintained, and articles disposed on and adjacent to the stroller can be prevented from being inadvertantly hooked and, thus, damaged thereby.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic side view of a conventional foldable stroller disclosed in German Utility Model No. 20 2005 0083690 in an unfolded state;

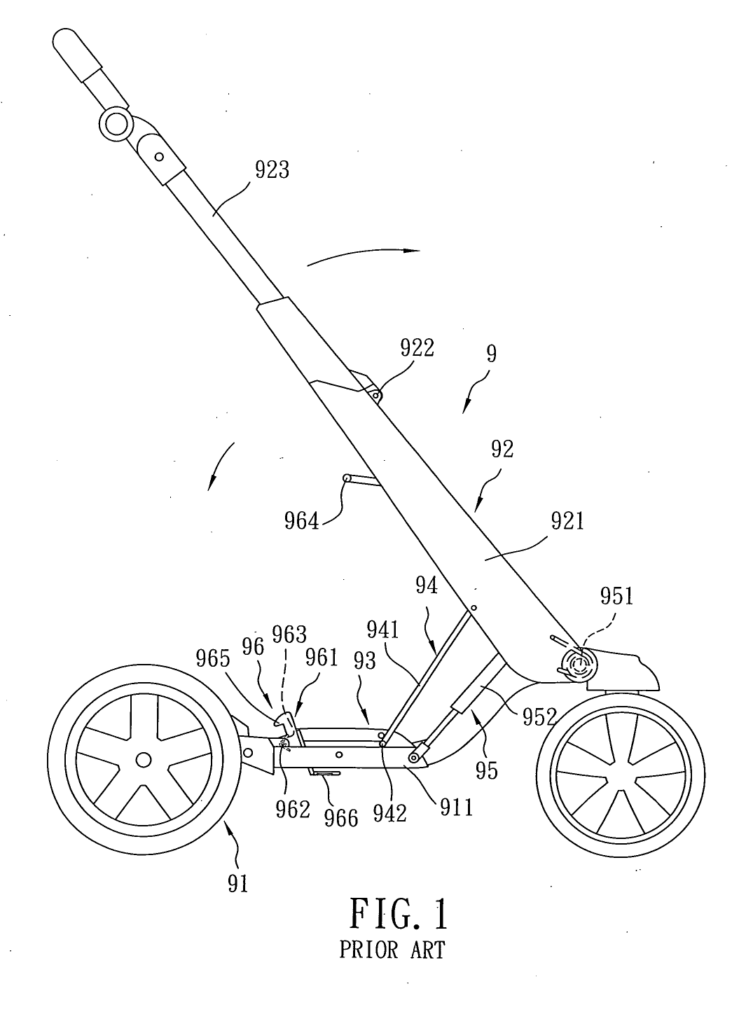

FIG. 2 is a schematic side view of the conventional foldable stroller in a folded state;

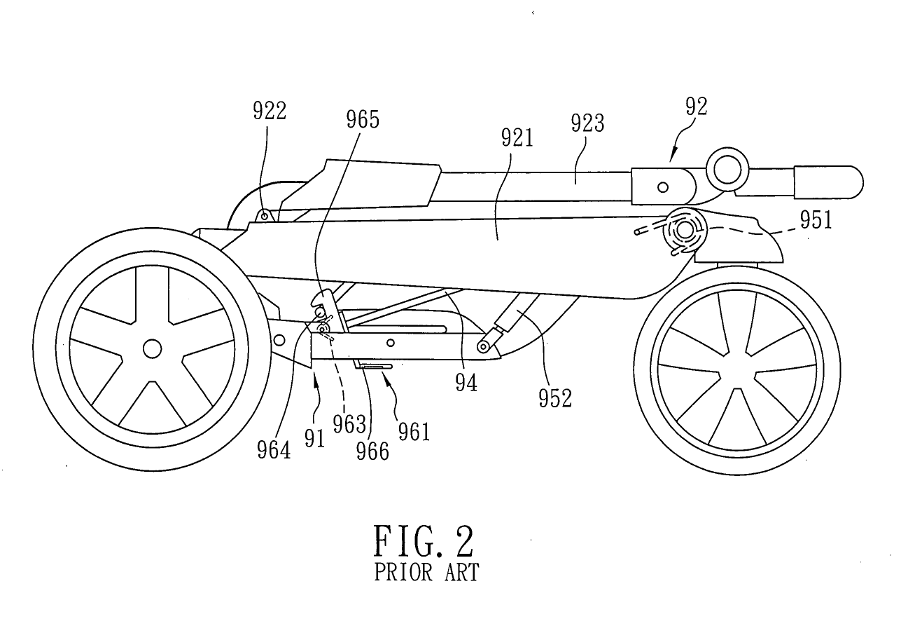

FIG. 3 is a schematic side view of the preferred embodiment of a stroller according to this invention in an unfolded state;

FIG. 4 is a fragmentary exploded perspective view of the preferred embodiment, illustrating a portion of a strut-positioning mechanism and a portion of a retaining mechanism;

FIG. 5 is a fragmentary side view of the preferred embodiment, illustrating how rotation of a grip member relative to a swing rod is prevented;

FIG. 6 is a fragmentary sectional view of the preferred embodiment, illustrating how a strut is locked at a normal position when the stroller is unfolded;

FIG. 7 is a fragmentary assembled perspective view of the preferred embodiment, illustrating a portion of a retaining mechanism;

FIG. 8 is a fragmentary sectional view of the preferred embodiment, illustrating a generally horizontal position of a hook plate;

FIG. 9 is a fragmentary sectional view of the preferred embodiment, illustrating how the strut is unlocked from the normal position and how the hook plate is moved to an upright position; and

FIG. 10 is a fragmentary sectional view of the preferred embodiment, illustrating how the hook plate is moved on a flexible retaining hook of a retaining seat.

### DETAILED DESCRIPTION OF THE PREFERRED EMBODIMENT

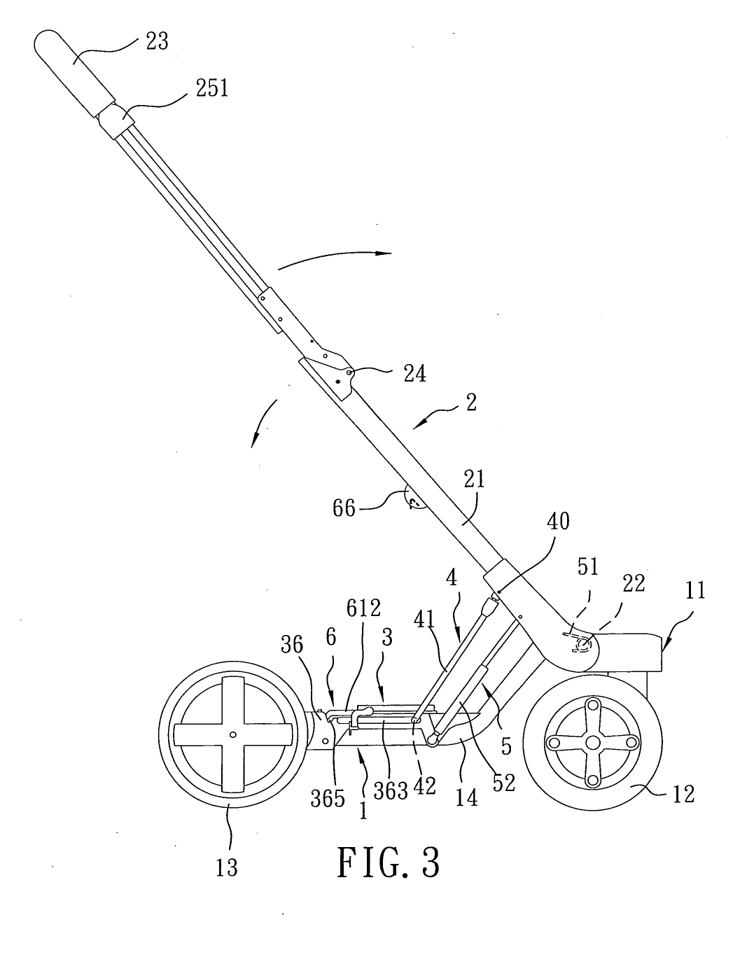

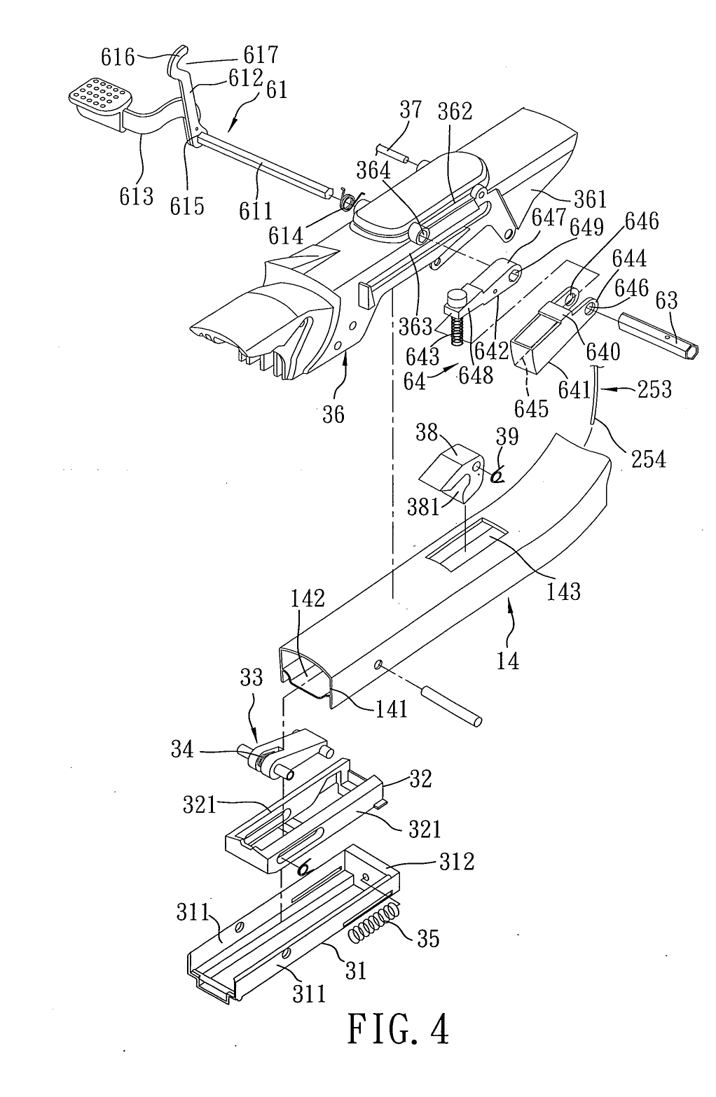

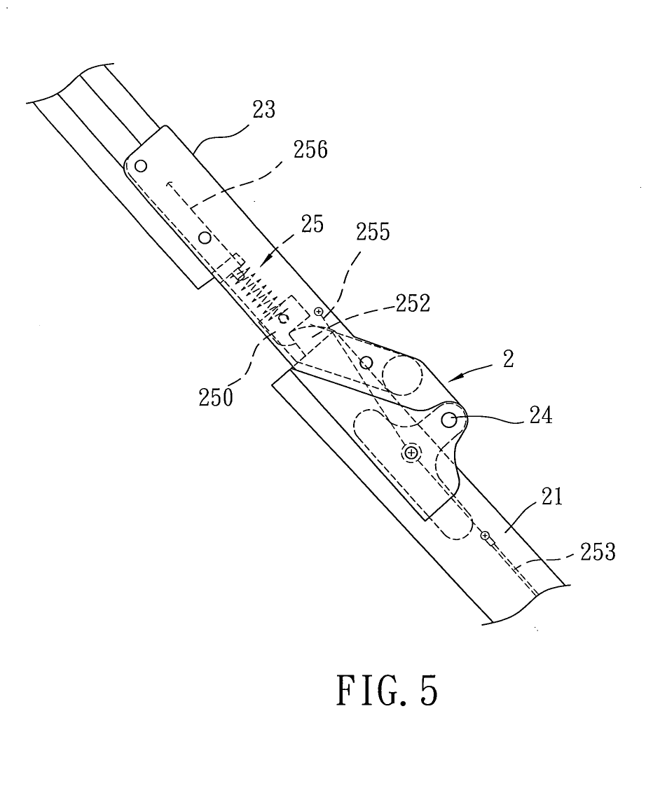

Referring to FIGS. 3, 4, and 5, the preferred embodiment of a stroller according to this invention includes a wheel frame 1, a handle frame 2 disposed pivotally on the wheel frame 1, two strut-positioning mechanisms 3, a strut 4, two separating mechanisms 5, and a retaining mechanism 6 for locking the stroller in a folded state.

The wheel frame 1 includes a front wheel seat 11, a front wheel unit 12 disposed under the front wheel seat 11, a rear wheel unit 13, and a pair of elongated left and right mounting seats 14 extending along a front-to-rear direction. Each of the left and right mounting seats 14 has an inclined front section and a horizontal section that includes a mounting wall 141 that is configured as a rectangular tube and that defines a passage 142. The mounting wall 141 is formed with an opening 143.

The handle frame 2 includes two swing rods 21, two first pivot pins 22 for connecting the swing rods 21 respectively and pivotally to a front end portion of the wheel frame 1, an inverted U-shaped grip member 23, two second pivot pins 24 for connecting the grip member 23 to the swing rods 21, respectively, and two grip-locking mechanisms 25. Each of the grip-locking mechanisms 25 includes a sliding sleeve 251 (see FIG. 3) sleeved movably on the grip member 23, a retaining block 252 attached to the corresponding swing rod 21, a movable block 250 disposed movably within the grip member 23 and biased to contact the retaining block 252 so as to prevent pivoting of the grip member 23 relative to the corresponding swing rod 21, a control cable 253 having a lower end extending into the passage 142 in the wheel frame 1, and an upper end fastened to the grip member 23, and a pull cable 256 having two ends fastened respectively to the sliding sleeve 251 and the movable block 250. The sliding sleeves 251 can be moved upwardly on the grip member 23 so as to remove the movable blocks 250 from the retaining blocks 252, respectively. This allows for forward and downward pivoting movement of the grip member 23 relative to the swing rods 21 and upward movement of the control cables 253.

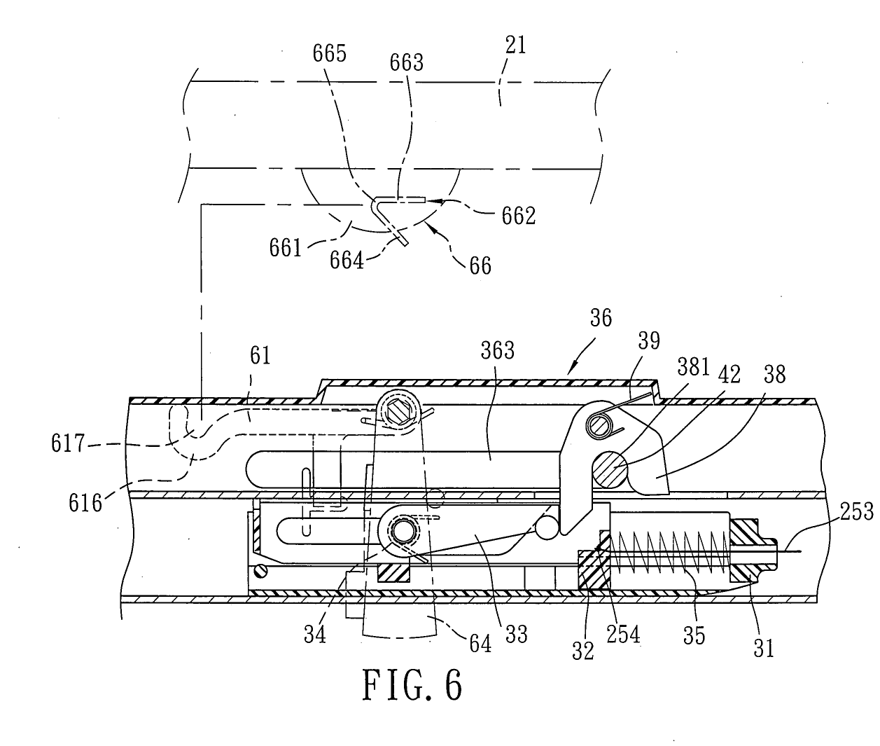

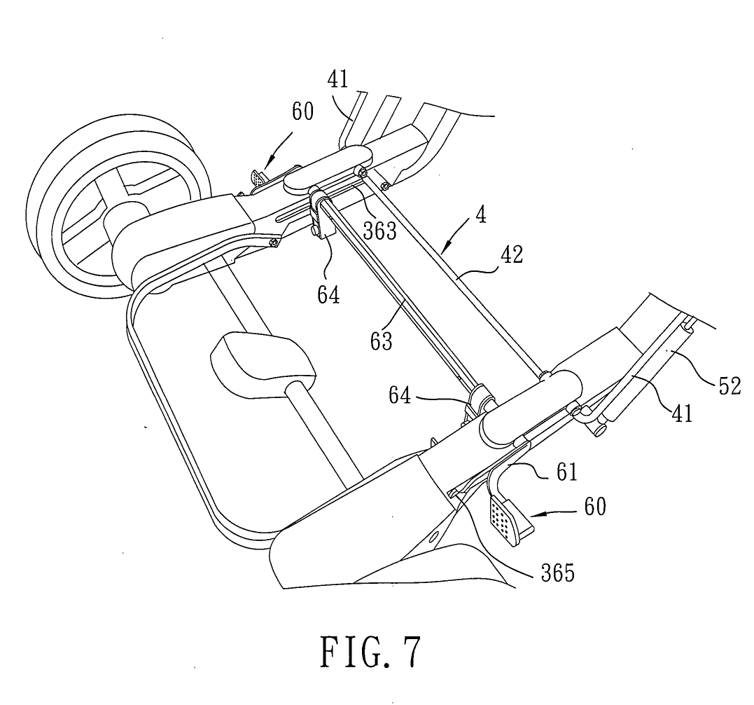

With further reference to FIGS. 6 and 7, the strut-positioning mechanisms 3 are spaced apart from each other along a left-to-right direction, and are disposed respectively on the mounting seats 14. Each of the strut-positioning mechanisms 3 includes a fixed seat 31 disposed fixedly within the corresponding passage 142, a sliding seat 32 movable forwardly and rearwardly between two sidewalls 311 of the fixed seat 31, a locking seat 33 disposed pivotally between two sidewalls 321 of the sliding seat 32, a torsional spring 34 for biasing the locking seat 33 to pivot downwardly, a compression spring 35 disposed between a front end wall 312 of the fixed seat 31 and the sliding seat 32 for basing the sliding seat 32 to move rearwardly, a cover body 36 disposed fixedly on the mounting seat 14, a positioning seat 38 disposed pivotally between two sidewalls 361 of the cover body 36, and a torsional spring 39 sleeved on a third pivot pin 37 for biasing the positioning seat 38 to a normal position shown in FIG. 6. Each of the cover bodies 36 further includes two mounting walls 362 disposed above and narrower than the sidewalls 361, two aligned slide slots 363 formed respectively in the sidewalls 361 and extending along a front-to-rear direction, and a recess 365 (see FIGS. 3 and 7) formed in an outer side surface of one of the sidewalls 361. Each of the mounting walls 362 is formed with an integral horizontal tube 364. Each of the positioning seats 38 has a retaining groove 381.

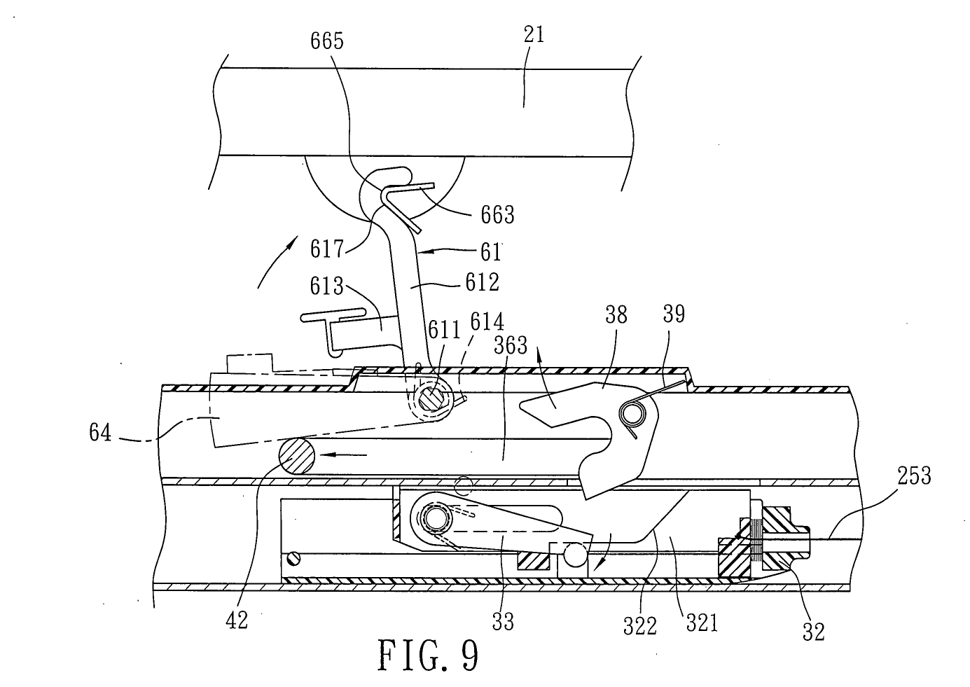

The strut 4 is convertible between a supporting position shown in FIG. 3, in which the strut 4 is inclined, and a non-supporting position shown in FIG. 9, in which the strut 4 is horizontal. The strut 4 includes a pair of inclined left and right supporting sections 41 disposed rotatably between the swing rods 21 by two fourth pivot pins 40, and a horizontal engagement section 42 connected fixedly to lower ends of the left and right supporting sections 41. The engagement section 42 has two end portions received respectively and slidably within the slide slots 363 in the cover body 36, and is disposed within the retaining grooves 381 in the positioning seats 38. As such, the strut 4 is connected pivotally to the handle frame 2 at a front end thereof, and is disposed movably and locked releaseably on the wheel frame 1 by the strut-positioning mechanisms 3.

Each of the separating mechanisms 5 includes a torsional spring 51 for biasing the handle frame 1 to pivot forwardly and upwardly to a normal position shown in FIG. 3, and a damping cylinder 52 disposed between the wheel frame 1 and an assembly of the swing rods 921.

The retaining mechanism 6 includes a pair of retaining hook units 60 spaced apart from each other along a left-to-right direction, a connecting member 63 co-rotatable with the retaining hook units 60, and a pair of retaining seats 66 attached respectively to the swing rods 21 of the handle frame 2. Each pair of the retaining hook units 60 and the retaining seats 66 is disposed respectively on left and right sides of an assembly of the wheel frame 1 and the handle frame 2. Each of the retaining hook units 60 includes a retaining hook member 61 disposed rotatably on the corresponding cover body 36, and a driving unit 64 for driving the retaining hook member 61.

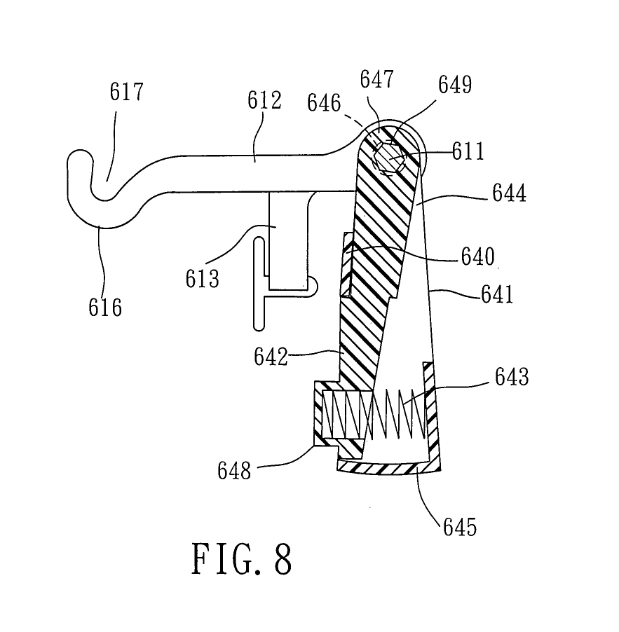

With additional reference to FIGS. 8 and 9, each of the retaining hook members 61 includes a horizontal rotatable rod 611 having a hexagonal cross section and journalled on the corresponding cover body 36, a hook plate 612 connected fixedly to the rotatable rod 611, a pedal 613 connected fixedly to the rotatable rod 611, and a torsional spring 614 for biasing the hook plate 612 to pivot downwardly. Each of the hook plates 612 has a coupling portion 615 connected fixedly to the corresponding rotatable rod 611, and a hook portion 616 that is connected fixedly to the coupling portion 615 and that has a groove 617. When the stroller is unfolded, each of the hook plates 612 is disposed in a generally horizontal position, that is, within the recess 365 of the corresponding cover body 36, as shown in FIG. 3.

The connecting member 63 is disposed between the cover bodies 36, and is configured as a hexagonal tube. The rotatable rods 611 engage fittingly the connecting member 63 so as to allow for co-rotation of the connecting member 63 with the rotatable rods 611. Each of the driving units 64 includes a first connecting seat 641, a second connecting seat 642 pivotable relative to the first connecting seat 641, and a resilient member 643 disposed between the first and second connecting seats 641, 642. Each of the first connecting seats 641 has a pivot end 644 sleeved rotatably on the corresponding rotatable rod 611, a biased end 645 opposite to the pivot end 644, and a stop portion 640 disposed between the pivot end 644 and the biased end 645. Each of the pivot ends 644 is formed with two circular holes 646 (only one is shown in FIG. 8) for extension of the corresponding rotatable rod 611 therethrough. Each of the second connecting seats 642 has a coupling end 647 sleeved on the corresponding rotatable rod 611, and a biased end 648 opposite to the coupling end 647. Each of the coupling ends 647 is formed with a hexagonal hole 649 engaging fittingly the corresponding rotatable rod 611 for co-rotation therewith. Alternatively, the cross section of the rotatable rods 611 and the holes 649 may be of other non-circular complementary shapes (e.g., rectangular and square). Each of the resilient members 643 is disposed between and in contact with the corresponding biased end 645 and the corresponding biased end 648. During pivoting movement of the second connecting seats 642 relative to the first connecting seats 641, when the second connecting seats 642 come into contact with the stop portions 640, further such pivoting movement can be prevented. Each of the retaining seats 66 includes a mounting plate 661 attached fixedly to the corresponding swing rod 21, and a generally V-shaped flexible retaining hook 662 having a fixed hook portion 663 fastened to the mounting plate 661, a pivotable hook portion 664, and a bent portion 665 interconnecting fixedly the fixed hook portion 663 and the pivotable hook portion 664 and having a shape complementary to that of the groove 617 in the corresponding hook plate 612.

With particular reference to FIGS. 3, 6, and 8, when the stroller is unfolded, the handle frame 2 is inclined rearwardly and upwardly, and the engagement section 42 of the strut 4 is confined within the retaining grooves 381 in the positioning seats 38. In this state, since each of the locking seats 33 is biased by the corresponding torsional spring 34 to press against the corresponding locking seat 38, the strut 4 is locked at the supporting position. Furthermore, the hook portions 616 of the hook plates 612 are concealed respectively within the recesses 365 in the cover bodies 36. Since the hook plates 612 do not project upwardly from the wheel frame 1, the integral outer appearance of the stroller can be maintained, and articles disposed on and adjacent to the stroller can be prevented from being hooked and, thus, damaged thereby.

With particular reference to FIGS. 3, 5, and 9, when it is desired to fold the stroller, the sliding sleeves 251 are pulled upwardly to thereby remove the movable blocks 250 from the retaining blocks 252, respectively. Subsequently, the grip member 23 is pivoted forwardly and downwardly about the second pivot pins 24. This allows each of the control cables 253 to pull the corresponding sliding seat 32 forwardly relative to the corresponding fixed seat 31. When the sliding seats 32 move forwardly, front ends of the retaining seats 33 are pushed respectively by two inclined guiding surfaces 322 of the sliding seats 32 to pivot downwardly. Hence, the positioning seats 38 are pivoted respectively by the torsional springs 39 so as to allow for rear movement of the engagement section 42 of the strut 4 along the slide slots 363 in the cover bodies 36. Since cooperation between the strut-positioning mechanisms 3 and the strut 4 is disclosed in German Utility Model No. 20 2005 0083690, a further description thereof will be omitted herein.

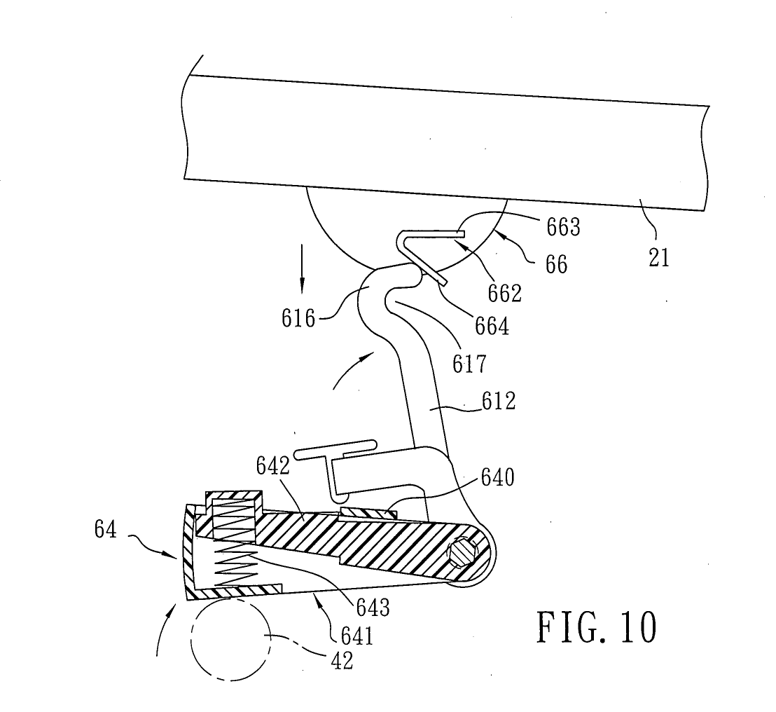

With particular reference to FIGS. 3, 9, and 10, during folding of the stroller, the retaining seats 66 pivot downwardly with the swing rods 21, respectively, and the engagement section 42 moves rearwardly along the slide slots 363, as described above, to thereby contact and pivot the first connecting seats 641 upwardly. Hence, each of the first connecting seats 641 pivots the corresponding resilient member 643 and, thus, the corresponding second connecting seat 642 upwardly. As a result, the hook plates 612 are also pivoted upwardly to thereby contact and move on the pivotable hook portions 664 of the retaining hooks 662, respectively, as shown in FIG. 10, due to the fact that the second connecting seats 642 are connected respectively and fixedly to the retaining hook members 61. When the hook plates 612 move on the pivotable hook portions 664, respectively, the resilient members 643 are compressed. As soon as the hook portion 626 of each of the hook plates 612 moves beyond the bent portion 665 of the corresponding retaining hook 662, the corresponding resilient member 643 expands to bias the corresponding groove 617 to engage the bent portion 665 of the corresponding retaining hook 662 so as to dispose the corresponding hook plate 612 in an upright position. As such, the stroller can be automatically locked at the folded state.

Thereafter, either of the pedals 613 of the retaining hook members 61 can be stepped on to remove the hook plates 612 from the retaining hooks 662, respectively. Hence, the hook plates 612 are biased by the torsional springs 614 to return to the horizontal positions, and the torsional spring 51 biases the handle frame 2 to the normal position. In addition, the engagement section 42 of the strut 4 is moved forwardly by the handle frame 2 until it is confined within the retaining grooves 381 in the positioning seats 38.

With this invention thus explained, it is apparent that numerous modifications and variations can be made without departing from the scope and spirit of this invention. It is therefore intended that this invention be limited only as indicated by the appended claims.

I claim:

1. A stroller comprising:
a wheel frame;
a handle frame disposed pivotally on a front end portion of said wheel frame;
at least one strut-positioning mechanism disposed on said wheel frame;
a strut having a front end connected pivotally to said handle frame, and a rear end disposed movably on said wheel frame and locked releaseably on said wheel frame by said strut-positioning mechanism; and
a retaining mechanism for locking said stroller in a folded state;
wherein said retaining mechanism includes:
at least one retaining seat attached to said handle frame; and
at least one retaining hook unit including a hook plate that is disposed in a generally horizontal position on said wheel frame; and
when said stroller is folded, said hook plate is pivoted upwardly to an upright position whereat said hook plate engages said retaining seat so as to lock said stroller in the folded state.

2. The stroller as claimed in claim 1, wherein said retaining hook unit of said retaining mechanism includes:
a cover body disposed fixedly on said wheel frame;
a rotatable rod journalled on said cover body and connected fixedly to said hook plate;
a pedal connected fixedly to said rotatable rod; and
a torsional spring for biasing said hook plate to said horizontal position.

3. The stroller as claimed in claim 1, wherein said retaining seat includes a generally V-shaped flexible retaining hook fastened to said handle frame and having a bent portion, said hook plate having a hook portion defining a groove for engaging said bent portion of said retaining hook when said stroller is folded.

4. The stroller as claimed in claim 2, wherein said strut is convertible between a supporting position whereat said strut is inclined, and a non-supporting position whereat said strut is horizontal, and said retaining mechanism further includes:
a first connecting seat sleeved rotatably on said rotatable rod and pivoted upwardly by said strut when said stroller is folded;
a second connecting seat sleeved on and co-rotatable with said rotatable rod; and
a resilient member interposed between said first and second connecting seats such that said resilient member and said second connecting seat are pivoted upwardly by said first connecting seat, thereby pivoting said hook plate to said upright position when said strut is converted from said supporting position to said non-supporting position.

5. The stroller as claimed in claim 4, wherein said first connecting seat is formed with a circular hole, said second connecting seat being formed with a non-circular hole, said rotatable rod extending through said circular hole in said first connecting seat and engaging fittingly said non-circular hole in said second connecting seat so as to allow for synchronous rotation of said second connecting seat and said rotatable rod.

6. The stroller as claimed in claim 4, wherein said first connecting seat has a pivot end sleeved rotatably on said rotatable rod, a biased end in contact with said resilient member, and a stop portion disposed between said pivot end and said biased end such that, when said second connecting seat comes into contact with said stop portion of said first connecting seat, further pivoting movement of said second connecting seat relative to the said first connecting seat is prevented.

7. The stroller as claimed in claim 2, wherein said hook plate has a hook portion defining a groove for engaging said retaining seat, said cover body of said retaining hook unit of said retaining mechanism having a side surface that is formed with a recess, said hook portion being received within said recess.

8. The stroller as claimed in claim 1, wherein said retaining mechanism includes a pair of said retaining seats, and a pair of said retaining hook units, each pair of said retaining seats and said retaining hook units being disposed respectively on left and right sides of the assembly of said wheel frame and said handle frame, said retaining mechanism further including a driving unit interposed between said retaining hook units such that said retaining hook units can be driven by said driving unit.

9. The stroller as claimed in claim 2, wherein said cover body is formed with two aligned slide slots extending along a front-to-rear direction, said strut having an engagement section that is disposed at said rear end and that is received slidably within said slide slots in said cover body.
